(19) United States
(12) Patent Application Publication
(10) Pub. No.: US 2002/0160682 A1
(43) Pub. Date: Oct. 31, 2002

(54) ACOUSTICAL FIBROUS INSULATION PRODUCT FOR USE IN A VEHICLE

(76) Inventors: QINGYU ZENG, REYNOLDSBURG, OH (US); STEVE A. SCHUTTE, COLUMBUS, OH (US); LEE A. STAELGRAEVE, LAMBERTVILLE, MI (US)

Correspondence Address: OWENS CORNING, 2790 COLUMBUS ROAD, GRANVILLE, OH, 43023, US

(21) Appl. No.: 09/474,536

(22) Filed: Dec. 29, 1999

(51) Int. Cl. B32B 5/02; B32B 27/04; D04H 1/54; D04H 3/00; D04H 5/00; D03D 9/00; B32B 27/12

(52) U.S. Cl. 442/411; 428/192; 428/193; 442/85; 442/86; 442/409; 442/415; 442/394; 442/395; 442/35; 442/38

(57) ABSTRACT

An acoustical insulation product for a vehicle includes a blanket of fibers and a facing material adhered to a major surface of the blanket. The product has a perimeter flange made by pressing the facing material and an edge portion of the blanket together. The flange provides stiffness to the product, and the flange is capable of being held in place on the vehicle by an attachment system.

### TECHNICAL FIELD

This invention relates to fibrous insulation products, and more particularly this invention relates to fibrous insulation products suitable for such uses as acoustical insulation for vehicles, such as the underside of a truck engine hood.

### BACKGROUND OF THE INVENTION

Fibrous insulation is commonly formed by fiberizing molten material and depositing the fibers on a collecting conveyor. Some fibrous insulation products are made by transporting fibrous material through various secondary processes, such as wet processes, air laid processes, reorienting, carding, blending of different types of fibers, or other processes for forming a blanket of fibrous material. Typically the fibers for insulation products are mineral fibers, such as glass fibers, although some insulation products are made of organic fibers, such as polyester. Most fibrous insulation products contain a binder material to bond the fibers together where the fibers contact each other. A typical binder material for glass fiber insulation is a thermosetting urea phenol-formaldehyde binder that is applied to the glass fibers before they are collected on the collecting conveyor. The binder is cured by passing the bindered insulation product through an oven. In some products, the binder gives the insulation product resiliency for recovery after packaging. In most insulation products the binder provides stiffness and handleability so that the product can be handled and applied as needed in the insulation cavities of buildings, and in various other insulation applications, such as in appliances and heating, ventilating and air conditioning (HVAC) equipment, and in industrial applications. The binder also enables the insulation material to be molded into various shapes as needed. An important product attribute of such insulation products is good acoustical and thermal performance.

Attempts have been made to improve upon the urea phenol-formaldehyde binder used in conventional fiberglass insulation products. Insulation products having conventional binder must be cured in an oven typically at a temperature of about 450° F. (232° C.). Such a binder is water based, and curing the binder can only occur after driving off all the water. This requires a large amount of energy. Before the curing stage, the binder flows along the fibers to the fiber-to-fiber intersections. After the binder in a conventional product is cured, a significant percentage of the urea phenol-formaldehyde binder is in the form of lumps or pieces (beads) of solid material at the fiber-to-fiber intersections rather than in a fine surface coating or a fine connection from fiber to fiber. These non-fibrous lumps or pieces have a very low surface-area-to-mass ratio, and therefore this material fails to contribute significantly to blocking heat transfer through the insulation product by radiation. By the same token, the non-fibrous lumps do not provide any significant acoustical advantage. It would be advantageous if there could be developed an insulation product that provided a smaller portion of the binder material in non-fibrous form, thereby maximizing the surface area of the material for both acoustical and thermal benefits.

Another problem with the application of conventional binder materials is that applying the binder in a liquid form provides an opportunity for some of the binder material to escape as volatile or particulate organic materials, thereby necessitating expensive environmental protection procedures and equipment. Manufacturing fibrous insulation would be improved if the formation of volatile or particulate organic materials could be eliminated or reduced. Also, conventional bindered insulation products can be irritating when handled, and improvements to eliminate or reduce the scratchiness of insulation products would be helpful.

Highway traffic noise has become a great concern for the quality of life of those living or working near highways. A significant portion of this noise pollution is due to noise emissions from heavy moving vehicles, such as trucks. The major noise emission source of such trucks is from the engine compartment. A good acoustic insulation system in the engine compartment can play a significant role in minimizing noise emission from the vehicle.

U.S. Pat. No. 5,298,694 to Thompson et al. discloses an acoustical insulation product adapted to be applied to the panel of an inner door. The acoustical product comprises fine staple polymers mixed with bicomponent thermally activated binder fibers. The fibrous mixture is air laid to form the acoustical insulation product.

Although the above-mentioned practices have provided new opportunities for efficiencies, and in some cases new products, there is still a need for an insulation product, particularly for use in vehicles, that would provide good acoustical performance and easy handleability during installation. Such a product should exhibit a reduction in or elimination of skin irritation when handled. Further, such a product should be able to be tailored to fit the size and shape constraints required by the customer's application. Where the insulation product is used in the engine compartment of a vehicle, the product should have a high resistance to damage from external sources, such as oil and water spray.

### SUMMARY OF THE INVENTION

The above objects as well as other objects not specifically enumerated are achieved by an acoustical insulation product for a vehicle comprising a blanket of fibers and a facing material adhered to a major surface of the blanket. The product has a perimeter flange made by pressing the facing material and an edge portion of the blanket together. The flange provides stiffness to the product, and the flange is capable of being held in place on the vehicle by an attachment system.

According to this invention, there is also provided a truck hood acoustical insulation product comprising a blanket of polymer fibers and a facing material adhered to a major surface of the blanket. The product has a perimeter flange made by pressing the facing material and an edge portion of the blanket together. The flange provides stiffness to the product, and the flange is capable of being held in place on the underside of the truck hood by an attachment system.

According to this invention, there is also provided an acoustical insulation product for a vehicle comprising a blanket of polymer fibers and a water resistant facing material adhered to a major surface of the blanket. The product is capable of being held in place on the vehicle by an attachment system.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view in perspective of an acoustical insulation product according to the present invention.

FIG. 2 is a schematic view more detailed view of a portion of the fibers of the insulation product of FIG. 1.

FIG. 3 is a plan view of the underside of the acoustical insulation product if FIG. 1.

FIG. 4 is a view in elevation of the acoustical insulation product, taken along lines 4-4 of FIG. 3.

FIG. 5 is perspective front view of a truck in which the underside of the hood is insulated with the acoustical insulation product of the invention.

### DETAILED DESCRIPTION OF THE INVENTION

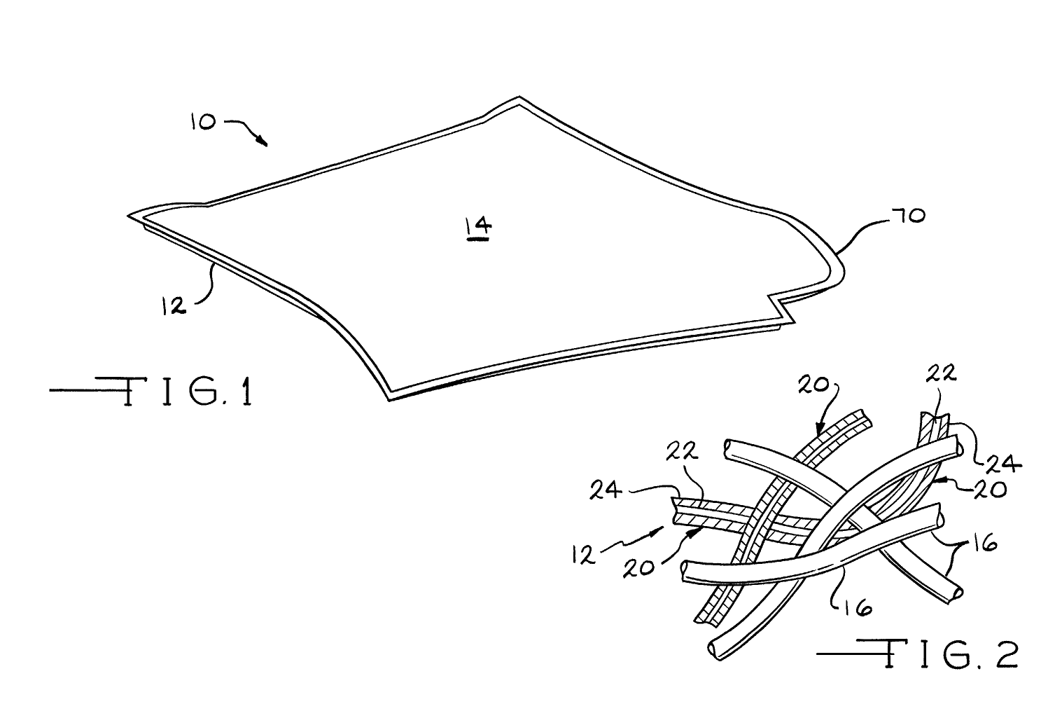

The acoustical insulation product of the invention, illustrated at 10 in FIG. 1, is comprised of a blanket 12 of fibers and a facing material 14. The acoustical insulation product 10 is formed into a shape required to meet the contours of the particular application or use for which the acoustical insulation product is intended.

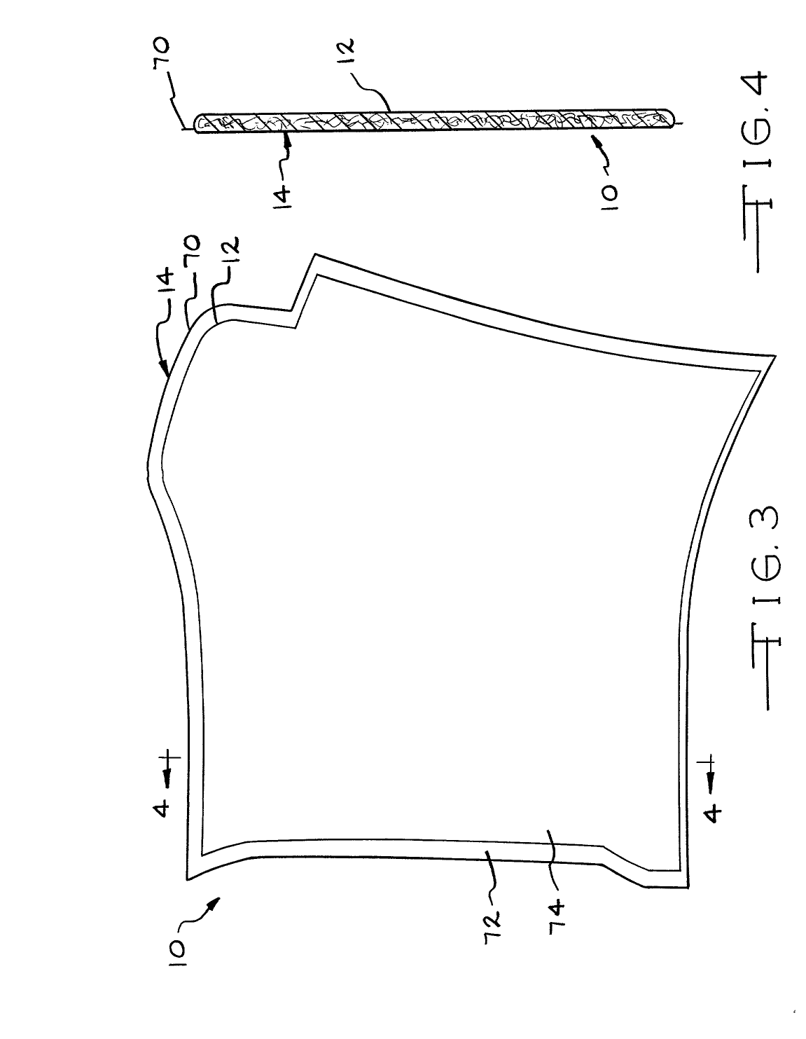

As shown in FIG. 2, the fibers of the acoustical insulation product 10 typically include primary fibers 16 and multicomponent fibers, in the form of bicomponent polymer fibers 20. It is to be understood that although bicomponent fibers are illustrated, other multicomponent fibers, such as tricomponent fibers, can be used with the invention. For purposes of clarity, the bicomponent polymer fibers 20 are shown in cross-section, while the primary fibers 16 are not. The bicomponent polymer binder fibers 20 are comprised of a principal polymer component 22 and a binder polymer component 24. The bicomponent polymer fibers 20 are shown as having been formed as sheath-core fibers, with the principal polymer component 22 forming a core material and the binder polymer component 24 forming a sheath around the core. It is to be understood that the bicomponent polymer fibers 20 can be formed in other arrangements, such as in a side by side arrangement, not shown. It can be seen that the binder polymer component 24 binds the bicomponent polymer fibers 20 and the primary fibers 16 to themselves and to each other.

The primary fibers 16 can be any type of fibers suitable for providing good structural qualities as well as good acoustical and thermal properties. Preferred fibers for use as the primary fibers 16 are polymer fibers. It is to be understood that the primary fibers can specifically be any mineral fibers such as fibers made of rock, slag and basalt, as well as glass fibers such as wool glass fibers, not shown. Wool glass fibers are well known in the art. A preferred type of primary fibers for use with the invention are made of polyethylene terephthalate (PET) fibers, preferably having a diameter within the range of from about 3 to about 30 microns. The primary fibers are preferably present in an amount that is within the range of from about 30 to about 95 percent by weight of the blanket of fibers, exclusive of the facing, and the bicomponent binder fibers are preferably present in an amount within the range of from about 5 to about 70 percent by weight. Most preferably, the primary fibers are PET fibers that are present in an amount that is within the range of from about 40 to about 80 percent by weight of the whole insulation product, exclusive of facings, and the bicomponent binder fibers are present in an amount within the range of from about 20 to about 60 percent by weight.

The introduction of the bicomponent polymer binder fibers 20 into the primary fibers serves two purposes. First the binder polymer component 24 supplies the binder necessary to bond the insulation product 10 together. Second, the bicomponent binder fibers are integrated as additional insulating fibers within the insulation product 10 to provide additional insulative value beyond that of the primary fibers 16. This additional acoustical and thermal insulative value is mainly derived from the additional fiber surface area of the bicomponent binder fibers which serves to block heat transfer by radiation through the insulation product, and also acts as a sound barrier and/or absorber. The addition of the bicomponent binder fibers adds not only the bonding capability, but also increases the strength of the product.

The binder polymer component 24 of the bicomponent polymer binder fibers 20 has a softening point lower than the softening point of the principal polymer component 22 so that upon heating the insulation product, the two materials will respond differently. More specifically, the insulation product 10 can be heated to a temperature that is above the softening point of the binder polymer component 24, but is below the softening temperature of the principal polymer component 22. This will cause the binder component to soften and become sticky, thereby bonding the various bicomponent polymer binder fibers 20 to themselves where they are in contact. Also, the softening of the binder polymer component 24 will bond the primary fibers 16 to themselves, and will bond the bicomponent polymer binder fibers 20 to the primary fibers 16. As long as the temperature is not raised as high as the softening point of the principal polymer component 22, that component will remain in the form of fibers. A particular advantage in using a binder polymer component 24 that is raised to its softening point is that the polymer binder material will not exhibit a significant flow during the heating process. With a non-flowing binder system there will be fewer undesirable binder particles or beads that are typically formed at the fiber-to-fiber intersections of prior art insulation products. The urea phenol-formaldehyde binder systems of the prior art produce a product with a large number of these beads. Without these beads the product of the present invention has a lower product K value or an increased resistance to flow of heat through the insulation product. Another result is higher surface area and air resistively for good acoustic performance.

Many combinations of materials can be used to make the bicomponent polymer binder fibers 20, including combinations using PET (polyester), polypropylene (PP), polysulfide, polyolefin, and polyethylene (PE), as well as other fibers. Combinations for the principal component/binder component can include PET/PP, PET/PE, PET/PET and PP/PE. Typical combinations are PET/PET and PP/PE. The binder polymer component 24 can be made so that it has a softening point within the range of from about 150 to about 400° F., and more preferably within the range of from about 170 to about 300° F. Most preferably the binder polymer component 24 is a thermoplastic material, which for purposes of this invention is defined as a low temperature heat-softenable plastic material, so that it can be subjected to multiple molding processes if desired. The principal polymer component 22 has a higher softening point, preferably above about 300° F., and most preferably above about 350° F.

A preferred combination of primary fibers 16 and binder fibers 20 is about 80 percent by weight 1.5 denier mono polyester staple fibers at about 1.5 inches in length, and about 20 percent 2 denier sheath-core bi-component sheath/core polyester fibers at about 2 inches in length. The blanket is about 1½ inches thick, and has a density of about 2.2 pcf.

The method of making the insulation product of the invention preferably includes the use of opening devices, not shown, to decouple the clustered fibrous masses of the input stock so that fiber contact becomes fiber-to-fiber rather than bundle-to-bundle. This increases the surface area of the total fiber collection, thereby increasing the thermal and acoustical properties of the ultimate insulation product. The opened fibers are then processed through any suitable forming device, such as a sheet former, not shown, to form a uniformly blended blanket 12 of fibers.

After the blanket 12 is formed, the facing material 14 is added. The facing material provides stiffness to the acoustical insulation product 10. The facing material also provides an acoustical barrier to prevent transmission of noise through the acoustical insulation product 10. Further, the facing material 14 provides a protective barrier to prevent liquids, grease and other materials from entering the fibrous blanket 12 and thereby causing a deterioration in the acoustical and thermal insulating properties of the blanket. Although a facing is shown on only one side of the blanket, it is to be understood that facing material can be fixed on both major surfaces of the product. The facing can be applied by direct thermal bonding or with an adhesive.

The facing material 14 can be any material suitable for providing the qualities of stiffness, noise barrier and insulation protection. A preferred facing material is a scrim web and a film, where the film has a softening point low enough so that when the facing material is heated, the film softens or melts and bonds the scrim web to the blanket 12. The film remains intact to the extent that it forms a moisture barrier over the surface of the acoustical insulation product to become water resistant to protect from penetration by moisture and other contaminants. The facing also provides some protection from puncturing. Another purpose of the facing material is that it provides the product with a resistance to mildew. The polymer material that makes up the facing material can be provided with a surface chemistry, such as containing fluorocarbon or silicon compounds, to improve the water and oil resistivity or other properties of the facing. In a preferred embodiment of the invention, the facing material is dark or black to disguise dirt, oil spots and other blemishes that invariably will soil the facing material. It is to be understood that additional facing layers, such as reinforcing layers or foil layers, can be added to the facing layer 14.

Most preferably, the scrim is made of black polyester spunbond nonwoven fibers and the film is a polypropylene adhesive film. For example, the scrim web can be a Fiber Dynamics polyester rayon nonwoven fabric having an acrylic binder and made with a fire retardant. The adhesive film can be a 15 mil thick blend of polyester and polyamide materials, and having a base weight of 1.9 oz. per square yard, a tensile strength in the machine direction of 25 pounds per square inch, a tensile strength in the cross direction of 10 pounds per square inch, and an elongation of 12 percent in the machine direction and 33 percent in cross direction.

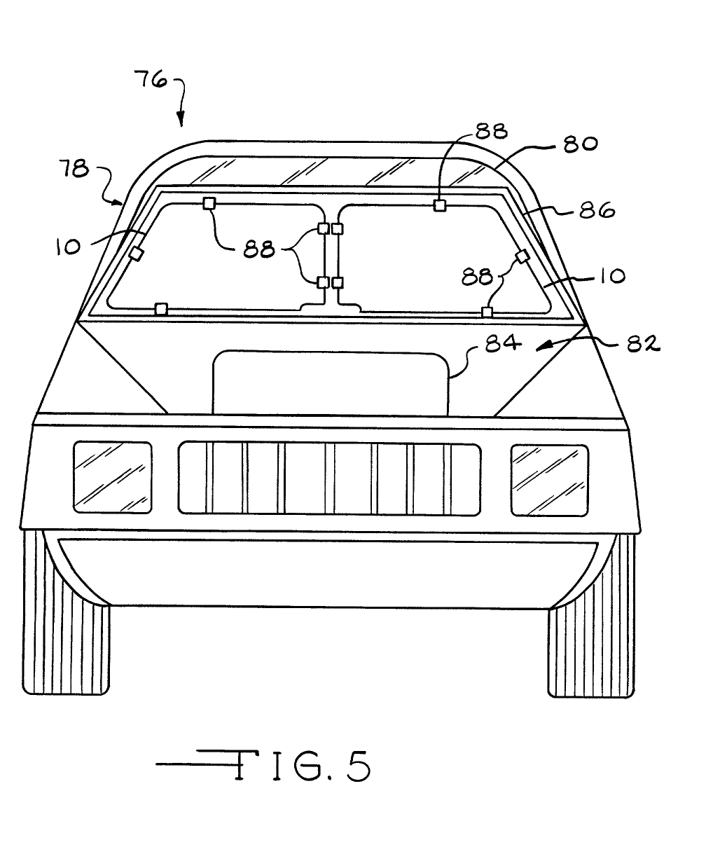

As shown in FIGS. 1, 3 and 4, the acoustical insulation product 10 can have a flange 70 around its perimeter. The flange 70 helps provide stiffness and facilitates installation of the acoustical insulation product 10 into the vehicle. Further, the flange provides a good workpiece for cutting and fabrication with a clean edge, and helps prevent the product's being damages or worn during fabrication and installation. As can be seen from FIG. 4, the flange 70 is not centered midway through the thickness of the blanket 12, but rather is closer to the surface containing the facing material 14. The flange is preferably made by molding or pressing the edge portion 72 of the insulation product under conditions of an elevated temperature so that the bicomponent polymer binder fibers 20 soften and bond the primary fibers 16 to each other. Another term for the molding or pressing step is “debossing.” In some cases, the binder fibers bond the polymer fibers to the facing material. After this pressing operation the density of the edge portion of the blanket 12 is significantly greater than the density of the remainder portion 74 of the blanket 12. For example, the density of the remainder portion can be within the range of from about 0.5 to about 3.0 pounds per cubic foot (pcf), whereas the edge portion 72, after being pressed, might have a density above 10 pcf. Also, because of the compression of the fibers in the edge portion 72, the thickness of the flange 70 is considerably less than the thickness of the blanket. For example, the flange can have a thickness less than about 15 percent of the thickness of the blanket. The flange improves the integrity of the edge of the acoustical insulation product 10, and enhances its rigidity. The higher density at the edges of the acoustical insulation product reduces porosity, so that there is decreased moisture penetration into the fibrous blanket 12.

One of the advantages of the use of a polymer facing material of the invention over conventional vehicle hood insulation panels is that the polymer facing material exhibits a lower coefficient of friction than foam insulation products. An acoustical insulation product 10 of the invention can be more easily installed properly in an insulation cavity relative to foam insulation because the product of the invention can be more easily slid or maneuvered in place during installation. In contrast, conventional foam truck hoodliners do not slide easily within the brackets holding in the acoustical insulation product, and are therefore more difficult to accurately line up in the preferred orientation. Preferably, the surfaces of the insulation product 10 (i.e., both the blanket 12 and the facing material 14) have static coefficients of friction less than about 0.8, and more preferably less than about 0.5.

Another advantage of the fibrous insulation product of the invention is that it is more conformable than traditional foam hoodliners, thereby making it easier to install the insulation product in complicated hood geometries. The conformability and relatively easy slidability of the acoustical insulation product of the invention enable the insulation product to more successfully be retained in place under such environmental rigors as a wind turbulence and negative pressure within the engine compartment, and bumps in the road that cause the vehicle to be jolted.

As shown in FIG. 5, a truck 76 includes a cab 78 having a front window 80. The truck 76 includes an engine compartment 82, an engine 84, and an upraised hood 86. Attached to the underside of the hood 86 are two acoustical insulation products 10 according to the invention. The two insulation products 10 of the invention are held in place by an attachment system in the form of brackets 88. The attachment system can be any means suitable for fixing or installing the insulation product 10 in place on the underside of the hood 86. For example, the attachment system can be clips that are closed or clamped to the flange 70 of the acoustical insulation product 10. The attachment system can also be channels fixed to the underside of the hood 86. The attachment system can be in the form of a single piece around the perimeter of the acoustical insulation product, or can comprise a plurality of shorter members having a lip for securing or retaining the flanges 70 of the acoustical insulation product. It is to be understood that the brackets can be in the form of snaps or other types of fasteners.

Yet another advantage of the acoustical insulation product of the present invention is that the acoustical performance can be tailored to the customer's needs by selecting the appropriate thickness of the blanket 12, the fiber diameter of the fibers in the blanket, and the thickness and sound blocking character of the facing material 14. Further, the acoustical insulation product of the invention made with polyester fibers has a lower (i.e., better) flame spread rating than that of conventional polyurethane foam hoodliners, and also is much less combustible and produces lower carbon monoxide emissions than polyurethane foam hoodliners.

Although two insulation products 10 are shown in FIG. 5, it is to be understood that a single insulation product could be designed to insulate the hood 86. Further, although the acoustical insulation product is shown as being installed to insulate the hood of the vehicle, it is to be understood that the acoustical insulation product of the invention can be used to insulate other parts of vehicles, such as the wheelwells and the side panels of the engine compartment.

The principle and mode of operation of this invention have been described in its preferred embodiments. However, it should be noted that this invention may be practiced otherwise than as specifically illustrated and described without departing from its scope.

What is claimed is:

1. An acoustical insulation product for a vehicle comprising a blanket of fibers and a facing material adhered to a major surface of the blanket, the product having a perimeter flange made by pressing the facing material and an edge portion of the blanket together, the flange providing stiffness to the product, and the flange being capable of being held in place on the vehicle by an attachment system.

2. The acoustical insulation product of claim 1 in which the fibers are polymer fibers.

3. The acoustical insulation product of claim 1 in which the density of the edge portion of the blanket is significantly greater than the remainder portion of the blanket.

4. The acoustical insulation product of claim 1 in which the flange has a thickness less than about 15 percent of the thickness of the blanket.

5. The acoustical insulation product of claim 1 in which the facing material is water resistant.

6. The acoustical insulation product of claim 1 in which the facing material is a scrim web and a film, the film having been heat softened to adhere the film and scrim to the blanket of polymer fibers.

7. The acoustical insulation product of claim 6 in which the scrim is made of polyester fibers and the film is a polypropylene adhesive film.

8. The acoustical insulation product of claim 1 in which the surfaces of the insulation product have static coefficients of friction less than about 0.8.

9. The acoustical insulation product of claim 1 in which the blanket of polymer fibers includes polymer binder fibers that have been heated to a temperature sufficient to bond the polymer fibers to the facing material.

10. The acoustical insulation product of claim 1 in which the blanket of polymer fibers includes primary fibers and bi-component polymer binder fibers that are made of a principal polymer component and a binder polymer component, the binder component having a softening point lower than the softening point of the principal component, and the binder component having been heated to a temperature that is insufficient to soften the principal component but sufficient to soften the binder component to bond the multi-component polymer binder fibers and the primary fibers to themselves and to each other.

11. The acoustical insulation product of claim 10 in which the primary fibers are polyethylene terephthalate fibers and in which the bicomponent binder fibers include a core of polyethylene terephthalate and a sheath of polyethylene terephthalate.

12. A truck hood acoustical insulation product comprising a blanket of polymer fibers and a facing material adhered to a major surface of the blanket, the product having a perimeter flange made by pressing the facing material and an edge portion of the blanket together, the flange providing stiffness to the product, and the flange being capable of being held in place on the underside of the truck hood by an attachment system.

13. The acoustical insulation product of claim 12 in which the flange has a thickness less than about 15 percent of the thickness of the blanket.

14. The acoustical insulation product of claim 12 in which the facing material is water resistant.

15. An acoustical insulation product for a vehicle comprising a blanket of polymer fibers and a water resistant facing material adhered to a major surface of the blanket, the product being capable of being held in place on the vehicle by an attachment system.

16. The acoustical insulation product of claim 15 in which the facing material is a scrim web and a film, the film having been heat softened to adhere the film and scrim to the blanket of polymer fibers.

17. The acoustical insulation product of claim 16 in which the scrim is made of polyester fibers and the film is a polypropylene adhesive film.

18. The acoustical insulation product of claim 15 in which the surfaces of the insulation product have static coefficients of friction less than about 0.8.

19. The acoustical insulation product of claim 15 in which the blanket of polymer fibers includes primary fibers and bi-component polymer binder fibers that are made of a principal polymer component and a binder polymer component, the binder component having a softening point lower than the softening point of the principal component, and the binder component having been heated to a temperature that is insufficient to soften the principal component but sufficient to soften the binder component to bond the multi-component polymer binder fibers and the primary fibers to themselves and to each other.

20. The acoustical insulation product of claim 19 in which the primary fibers are polyethylene terephthalate fibers and in which the bicomponent binder fibers include a core of polyethylene terephthalate and a sheath of polyethylene terephthalate.
